(19) United States
(12) Patent Application Publication
(10) Pub. No.: US 2004/0088676 A1
(43) Pub. Date: May 6, 2004

(54) Document production

(76) Inventors: Charles J. Gazdik, Boise, ID (US); Shell S. Simpson, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/378,115

(22) Filed: Feb. 28, 2003

Related U.S. Application Data
(63) Continuation-in-part of application No. 10/283,495, filed on Oct. 30, 2002.
(63) Continuation-in-part of application No. 10/283,695, filed on Oct. 30, 2002.

(51) Int. Cl. G06F 9/44; G06F 15/173

(52) U.S. Cl. 717/101; 709/223

(57) ABSTRACT

Document production. The present invention arose from a need to deliver a document to a computing device as a server and to allow the server to produce the document without requiring user interaction. In various embodiments a document to be produced is received. A production application responsible for producing the document is initated. Calls from the production application to document production functions are caused to be redirected to proxy document production functions. The production is then instructed to produce the document.

### CROSS REFERENCE TO RELATED APPLICATIONS

This application is a continuation in part of application Ser. No. 10/283,495 entitled “Intercepting Calls to Common Dialog Functions” filed Oct. 30, 2002 and application Ser. No. 10/283,695 entitled “Intercepting Function Calls” also filed Oct. 30, 2002.

### FIELD OF THE INVENTION

The present invention generally relates to document production, and, more specifically, to document production not requiring user interaction.

### BACKGROUND

With the proliferation of handheld computing devices and wireless networking capabilities, it is often desirable for programming operating on a server to print a document. Using electronic mail, a web browser or other means of communication available on a mobile device, the user electronically sends the document to be printed to the server. The server saves the document using a temporary file name. On the mobile device the document was likely saved with a filename created and thus known by the user—for example, “c:\mydocuments\file.doc.” File management programming on the server, however, generates a new and typically a not so user friendly file name when temporarily storing the document—for example, “c:\winnt\temp\973498-98398843-09679-67267\t839348abcb5.tmp.” In doing so the file management software can erase the temporary file after it has been printed preventing the server from becoming cluttered with files that it no longer needs.

To print the document, programming on the server, such as a word processor or an internet browser, opens the temporarily stored file and issues print command. However, programming capable of printing documents usually requires user interaction to select various production options such as the number of copies, whether duplex printing is required, and, in many cases, to press enter on a keyboard or to click a print command button using a mouse. Where the server is geographically separated from the user, the user is not able to provide the interaction needed to direct printing. The user must instead rely on other programming operating on the server to supply the required interaction.

Moreover, when printing a document it is often desirable to include the document's filename in a header or footer added by the program responsible for printing. This enables the user or another party to later locate the electronic version of the document. When the document being printed is one temporarily stored on a server, the program responsible for printing only knows the document by its temporary filename. The programming has no knowledge of the filename by which the user identified the document. So when the document is printed, the temporary filename is placed in the header or footer. This information is of little, if any, use to the user. It also exposes information about the server that might be used by hackers to compromise the system.

### SUMMARY

Accordingly, the present invention arose from the need to deliver a document to a computing device such as a server allowing the device to produce the document without requiring user interaction. In various embodiments a document to be produced is received. A production application responsible for producing the document is initiated. Calls from the production application to a document production function are caused to be redirected to a proxy document production function. The production application is then instructed to produce the document.

### DESCRIPTION OF THE DRAWINGS

FIG. 1 is a block diagram illustrating the physical and logical components of a computer system.

FIG. 2 is flow diagram illustrating the steps taken to load an action module into operational memory.

FIGS. 3-8 are block diagrams illustrating the contents of the operational memory of FIG. 1 as the steps described in FIG. 2 are executed.

FIG. 9 is a schematic illustration of a computing environment in which various embodiments of the present invention may be incorporated.

FIG. 10 is a block diagram illustrating the hardware and programming contained on a server according to an embodiment of the present invention

FIG. 11 is a block diagram illustrating the logical programming elements of a remote production service.

FIG. 12 is a flow diagram illustrating steps taken to send a document to a server to be produced according to an embodiment of the present invention.

FIG. 13 a flow diagram illustrating steps taken to produce a document according to an embodiment of the present invention.

FIGS. 14-21 are block diagrams illustrating the contents of the operational memory of FIG. 10 as the steps described in FIG. 13 are executed according to an embodiment of the present invention.

### DETAILED DESCRIPTION

INTRODUCTION: Modern operating systems take a modular approach to supporting various applications. For example, a given operating system may make available a number of functions—those functions residing in a series of programming modules. However, a given application may only need a few of those functions. Consequently, programming for all of the functions provided by the operating system need not be loaded into a computer's memory—only the programming for those functions used by the application.

Operating systems such as Microsoft Windows® supply one or more production modules. These modules provide functions that enable a user to select a document production device or service such as a printer or fax software and for selecting production options such as the number of copies, two sided printing, and portrait or landscape page layout. The production modules supplied by an operating system are designed to provide interfaces for document production that respond to human input. The following is a partial list of the document production functions supplied by Microsoft Windows®: OpenPrinter( ), GetPrinter( ), SetPrinter( ), GetPrinterData( ), SetPrinterData( ), PrinterProperties( ), StartDocPrinter( ), EndDocPrinter( ), DocumentProperties( ), GetDeviceCaps( ), DeviceCapabilities( ), CreateDC( ), and CreatelC( ).

Where an electronic document is sent to a remote server, human interaction is often not an option. Software operating on the server requires a programmatic interface to produce the document. Also, it is often desirable to include the document's filename in the header or footer of the printed document. On the user's device, the document has a local filename known and likely created by the user. When sending the document to the server it is temporarily stored on the server using a temporary filename generated by the server's file management programming. It is by this temporary filename that the programming responsible for printing identifies the document. Unfortunately, the temporary filename is of little, if any, use to the user.

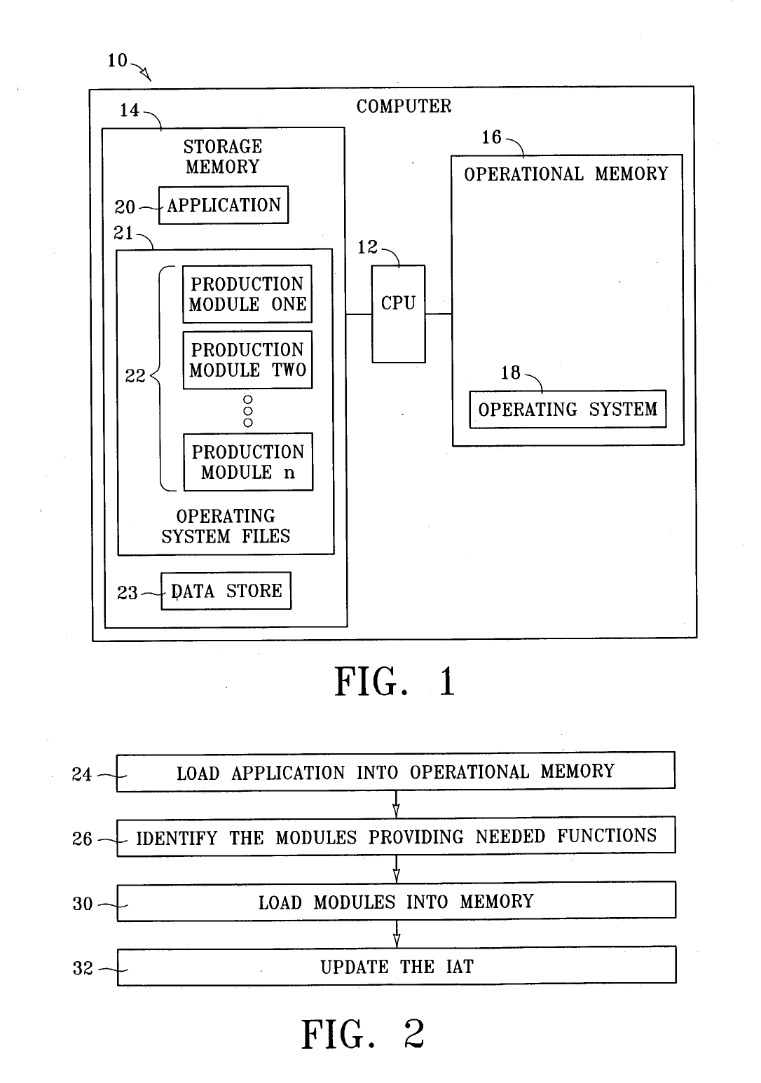

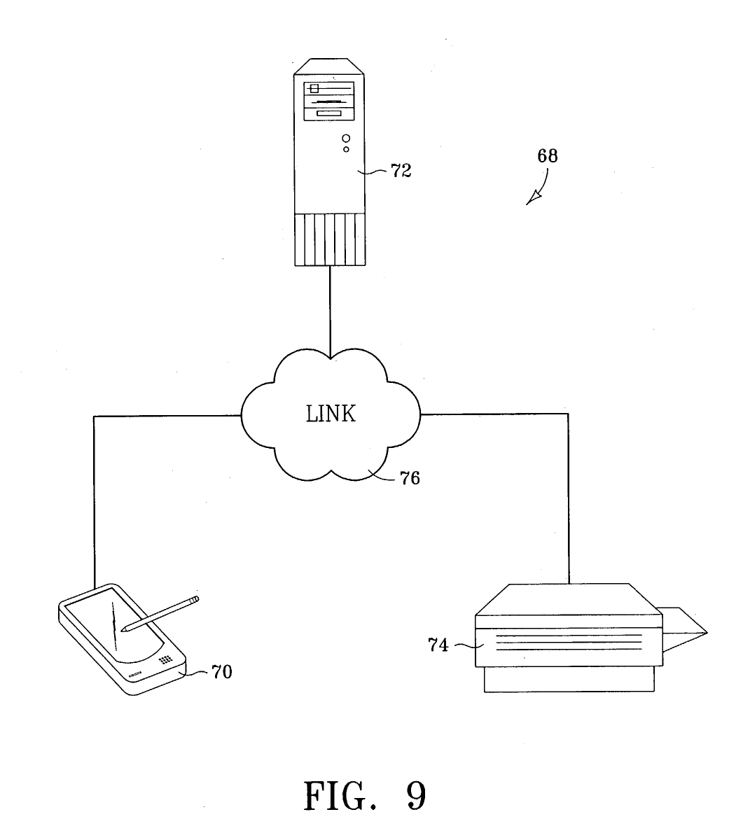

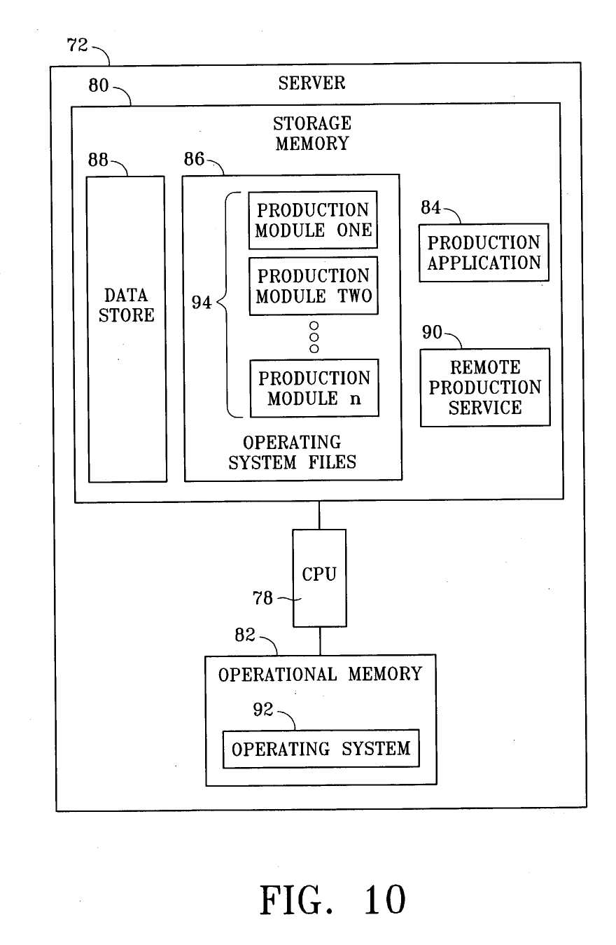

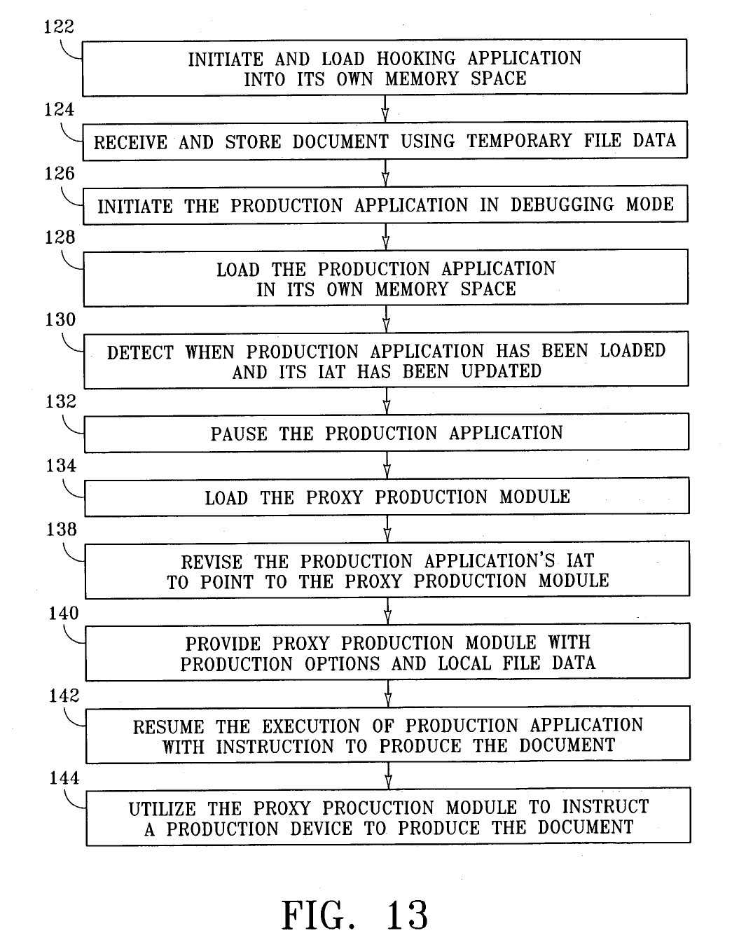

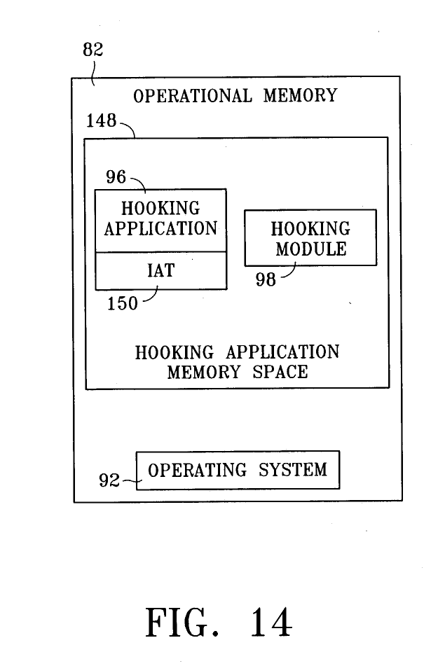

It is expected, then, that various embodiments of the present invention will operate to provide a programmatic interface for printing that is capable of identifying and utilizing a document's local filename rather than its temporary filename. In the description that follows, the steps taken to execute a computer application will be described with reference to FIGS. 1-8. The environment in which various embodiments of the present invention may be implemented is described with reference to FIGS. 9-11. Steps taken to practice an embodiment of the present invention are then described with reference to FIGS. 12 and 13. Finally, an example of one particular implementation of the present invention is described with reference to FIGS. 14-21.

APPLICATION EXECUTION: FIG. 1 is a block diagram illustrating some physical and logical components of a computer 10. Computer 10 includes CPU 12 (Central Processing Unit), storage memory 14, and operational memory 16. CPU 12 represents generally any processor capable of executing computer programs. Storage memory 14 represents generally any memory designated to store programs and other data when not being used by CPU 12. Typically, storage memory 14 is non-volatile memory able to retain its contents when computer 10 is switched off. Examples include hard disk drives, flash memory, and floppy disks. Operational memory 16 represents generally any memory designated to contain programs and data when in use by CPU 12. Typically, operational memory 16 is volatile memory which loses its contents when computer 12 is switched off. An example of operational memory 16 is RAM (Random Access Memory).

FIG. 1 illustrates computer 10 with only operating system 18 loaded into operational memory 16. Storage memory 14 contains application 20, operating system files 21 containing a series of production modules 22, and data store 23. Application 20 represents generally any computer program application. Production modules 22 represent generally any programming providing document production functions that may or may not be needed by application 20. Data store 23 represents a logical memory area for storing electronic files created and or used by application 20. For example, where application 20 is a word processor, data store 23 would contain word processing documents.

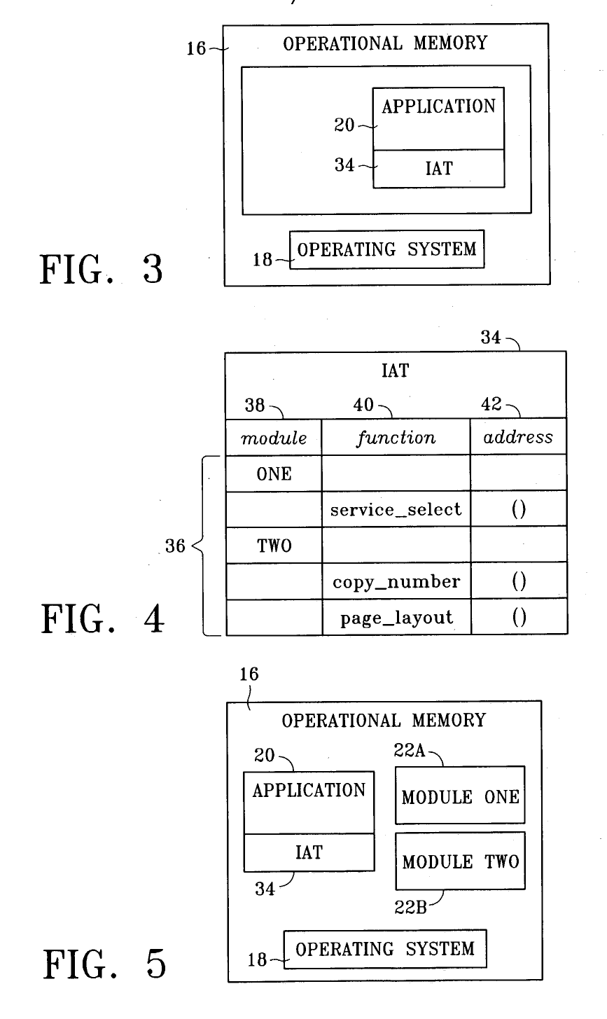

The steps taken to execute application 20 using an operating system such as Microsoft Windows® will be described with reference to FIG. 2. FIGS. 3-8 help to illustrate the contents of operational memory as the steps of FIG. 2 are carried out. Upon direction from a user or other programming, operating system 18 accesses storage memory 14, locates application 20, and loads application 20 into operational memory 16 (step 24). Operating system 18 identifies those production modules 22 that contain programming that supply document production functions needed by application 20 (step 26). Application 20 includes an IAT (Import Address Table). The IAT is an array used by application 20 to identify the memory address of the modules identified in step 26. The IAT, when functional, associates a unique memory address with a name identifying each function of each identified module. However, as the identified modules have not yet been loaded into operational memory 16, the IAT, at this point, contains the names of the identified modules and the relevant functions provided by each. It does not contain addresses.

Operating system 18 loads the production modules 22 identified in step 26 into operational memory 16 (step 30). Operating system 18 identifies the memory addresses of the document production functions provided by each of the loaded modules 22 and updates the IAT rendering the IAT functional (step 32). Operating system 1 8 now executes application 20. When application 20 makes a call to a document production function supplied by a loaded production module 22, the address of that function can be identified in the IAT.

FIGS. 3 and 4 illustrate the contents of operational memory 16 following step 26 in which operating system 18 loaded application 20. Operational memory 16 contains application 20 with IAT 34. IAT 34 includes a series of entries 36—separate entries referencing each module 22 that application 20 needs to operate and each document production function called by application 20 that is provided by those modules 22. Each entry 36 includes a module field 38, a function field 40, and an address field 42. For each entry 36 referencing a module 22, the module field 38 contains a name identifying that module 22. For each entry 36 identifying a document production function, the function field 40 contains a name identifying that document production function. In the example of FIG. 3, application 20 needed modules one and two to operate.

The address fields 42 are empty at this point as the modules 22 needed by application 20 to operate have not been loaded. Within module one, application 20 calls a function labeled “service_select.” Within Module two, application 20 calls functions labeled “copy_number ” and “page_layout.” Modules one and two may provide other functions, but only those listed in IAT 34 are needed by application 20.

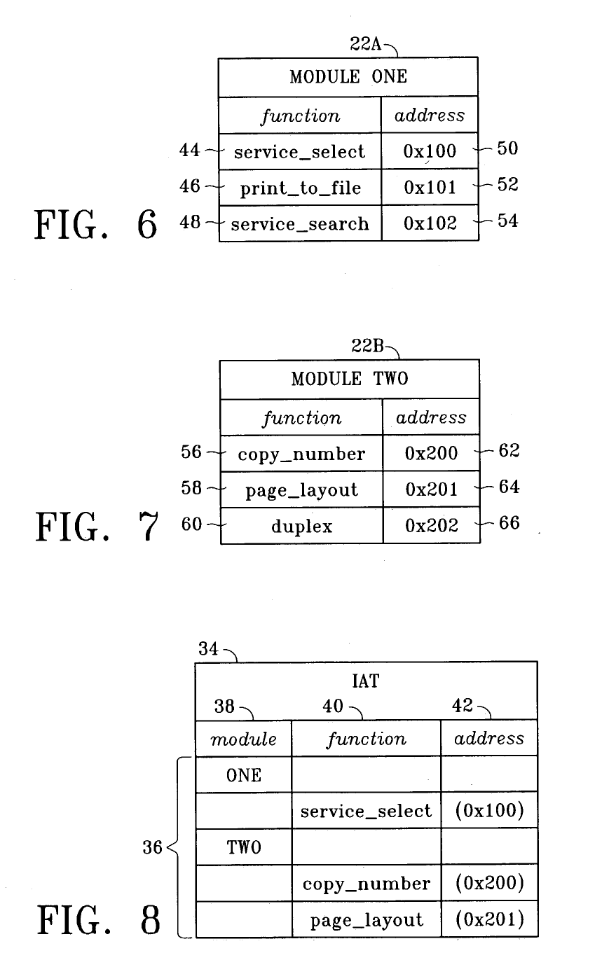

FIG. 5 illustrates the contents of operational memory 16 following step 30 in which operating system 18 loads the modules 22 needed by application 20 into operational memory 16. The needed modules are labeled module one 22A and module two 22B which are illustrated in more detail in FIGS. 6 and 7 respectively. Module one 22A contains programming providing functions labeled service_select 44, print_to_file 46, and service_search 48. Operating system 18 has loaded the programming for each of these functions into one of a series of memory addresses 50-54. Module two 22B contains programming providing functions labeled copy_number 56, page_layout 58, and duplex 60. Operating system 18 has loaded the programming for each of these functions into one of a series of memory addresses 62-66.

FIG. 8 illustrates the contents of IAT 34 following step 30 in which operating system 18 updates IAT 34. IAT 34 now contains addresses for the service_select, copy_number , and page_layout functions. Whenever application 20 makes a call to any one those document production functions, application 20 or operating system 18 can access IAT 34 to identify the address for that function.

ENVIRONMENT: FIG. 9 is a schematic representation of a computing environment 68 in which various embodiments of the present invention may be incorporated. Environment 68 includes user device 70, server 72, and production device 74. User device 70 and production device 74 are connected to server 72 via link 76. Link 76 represents generally any cable, wireless, or remote connection via a telecommunication link, an infrared link, a radio frequency link, or any other connector or system that provides electronic communication. Link 76 may represent an intranet, the Internet, or a combination of both. Devices 70-74 can be connected to link 76 at any point and the appropriate communication path established logically between the devices.

Production device 74 represents generally any combination of hardware and programming capable of producing a document. Examples of document production include printing, faxing, and distribution via electronic mail. User device 70 represents generally any combination of hardware and/or programming capable of transmitting an electronic document to server 72 over link 76. In the example of FIG. 9, user device 70 is a PDA (Personal Digital Assistant). However, user device 70 may be any type of computing device. Server 72 represents generally any combination of hardware and programming capable of directing production device 74 to produce a document received from user device 70. While FIG. 10 illustrates user device 70 and server 72 as two different devices, the functions provided by each (described below) may be incorporated into a single device or three or more devices.

FIG. 10 illustrates the hardware and programming elements of server 72. Server 72 includes CPU 78, storage memory 80, and operational memory 82. Storage memory 80 contains production application 84, operating system files 86 which include production modules 94, data store 88, and remote production service 90. CPU 78 represents generally any processor capable of executing production application 84 and remote production service 90. Operational memory 82 includes operating system 92 which represents generally any programming capable of loading production application 84 and remote production service 90. Operating system 92 is also responsible for loading production modules 94 into operational memory 82 allowing production application 84 to be executed by CPU 78.

Production application 84 represents generally any programming serving a document production function on server 72. Examples include word processors, spreadsheet applications, web browsers, image editing applications, and other applications capable of producing a document. Operating system files 86 represent generally any programming capable of supporting the execution of an application. Typically, a given operating system file is not loaded into operational memory 82 until an application that relies on the programming functions offered by that file is also loaded. As examples of such programming, each production module 94 represents generally any programming supplying a document production function or functions used by production application 84. One or more production modules 94 are responsible for providing an interface enabling a user to provide the selections required to produce a document. Such selections include, but are not limited to, identifying a production device such as a printer, paper size and orientation, as well as color and resolution settings.

Data store 88 represents generally a logical memory area for storing electronic files used by production application 84. Remote production application 90 represents generally any programming capable of altering, in a manner described below, production application 84 after production application 84 has been loaded into operational memory 82 in order to produce a document received from user device 70 (FIG. 9). As CPU 78 executes production application 84 calls are made to functions provided by one or more production modules 94. However, the alterations caused by remote production application 90 cause those calls to be redirected to proxy production functions provided by a proxy production module. A given proxy production function, for example, may provide a programmatic interface where the document production function it replaces would have provided a user interface.

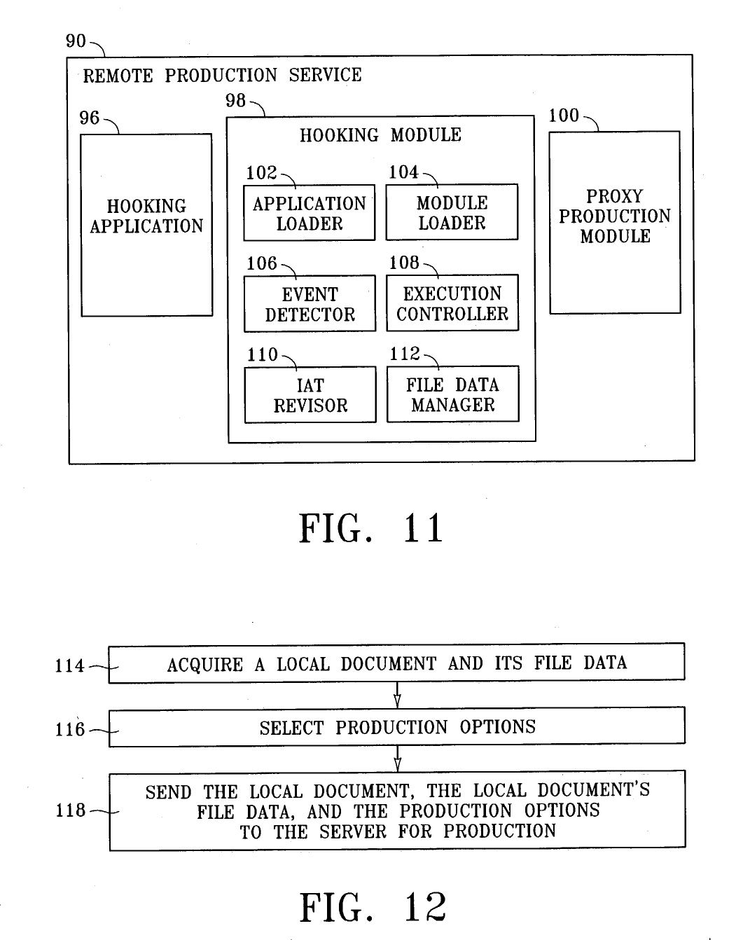

FIG. 11 is a block diagram illustrating the logical programming elements of remote production service 90. Remote production service 90 includes hooking application 96, hooking module 98, and proxy production module 100. Hooking application 96 represents any programming capable of altering production application 84 such that calls from production application 84 to a function or functions provided by one or more production modules 94 are redirected to document production functions provided by proxy production module 100. Hooking module 98 represents generally any programming providing functions needed by hooking application 96. While hooking module 98 is illustrated as a single module, the functions it provides may instead be provided by two or more modules. Proxy production module 100 represents generally any programming capable of replacing functions provided by one or more production modules 94.

Hooking module 98 includes application loader 102, module loader 104, event detector 106, execution controller 108, IAT reviser 110, and file data manager 112. Application loader 102 represents generally any programming capable of loading production application 84 into its own memory space in operational memory 82 and then initiating production application 84 in debugging mode.

A memory space is a portion of operational memory 82 reserved for a particular application and any modules it may need to operate. Each application loaded into operational memory 82 is loaded into its own unique memory space. Reserving a unique memory space for each application helps to prevent the operation of one application from interfering with the operation of another. In debugging mode, production application 84 operates normally except hooking application 96 retains control over certain aspects of production application 84. For example, hooking application 96 can pause and resume execution of production application 84 upon detection of certain events. Hooking application 96 also retains the ability to load programming into the memory space of production application 84.

Module loader 104 represents generally any programming capable of loading proxy production module 1 00 into the memory space of production application 84. Event detector 106 represents any programming capable of detecting one or more events in the execution of production application 84. An example of such an event includes the occurrence of when production application 84 has been loaded into operation memory 82 and its IAT has been populated with the addresses for functions provided by production modules 94. Execution controller 108 represents generally any programming operable to pause and resume the execution of production application 84. IAT reviser 110 represents any programming capable of identifying, in an import address table for production application 84, document production functions provided by production modules 94. For one or more of the identified functions, IAT reviser 110 is also responsible for replacing an address used to access that document production function with an address used to access a proxy document production function provided by proxy production module 100.

File data manager 112 represents generally any programming capable of providing proxy production module 100 with file data for a document. File data includes such information as the document filename which may or may not include its path. Take the filename c:\mydcoments\paper.doc for example; the filename's path is c:\mydocuments.

OPERATION: The steps taken by programming operating on user device 70 to initiate the production of a document will first be described with reference to FIG. 12. Initially, a user directs programming operating on user device 70 to acquire a local document to be produced along with its local file data (step 114). The document's local file data represents the documents filename and path on user device 70. Production options for the document are selected (step 116). The local document, its file data, and the selected production options are sent to server 72 for production (step 118).

The steps taken to produce the document acquired in step 114 will now be described with reference to FIG. 13. Operating system 92 loads hooking application 96 (along with hooking module 98) into its own memory space in operational memory 82 (step 122). After being executed by CPU 78, hooking application 96 receives the document along with the document's local file data and production options received from user device 70 in step 118 of FIG. 12. Hooking application 96 generates and uses a temporary file name to store the document on server 72 in data store 88 (step 124).

Hooking application 96 initiates production application 84 in debugging mode (step 126). Operating system 92, then, reserves a memory space in operational memory 82 for production application 84 and loads production application 84 into that memory space (step 128). Operating system 92 loads the production modules 94 providing document production functions called by production application 84. Operating system 92 updates the IAT for production application 84 to contain the addresses for those document production functions used by production application 84. Hooking application 96 detects when production application 84 has been loaded and its IAT has been updated (step 130) and, in turn, pauses the execution of production application 84 (step 132).

With production application 84 paused, proxy production module 100 is loaded into the memory space for production application 84 (step 134). To do so hooking application 96 reserves a memory chunk within the memory space for production application 84. Hooking application 96 loads “bootstrap code” into the reserved memory chunk. Bootstrap code represents generally any programming capable of loading proxy production module 100 into the memory space of production application 84 and to make a call to a function or functions used by production application 84. Hooking application 96 modifies the IAT for production application 84 so that an address for a function called early in the execution of production application 84 is replaced with an address pointing to the bootstrap code. When production application 84 is started, it makes a call to the function using the address in the IAT. Because the address has been changed, the call is routed to the bootstrap code. The bootstrap code loads proxy production module 100 into the memory space of production application 84. In order to preserve the expected behavior of production application 84, the bootstrap code then makes a call to the function production application 84 would have called had its IAT not been modified to include the address for the bootstrap code.

Hooking application 96 revises the IAT for production application 84. In doing so, hooking application 96 identifies addresses pointing to one or more document production functions provided by one or more loaded production modules 94. Hooking application 96 then replaces the identified addresses with addresses pointing to one or more proxy document production functions provided by proxy production module 100 (step 138). Hooking application 96 provides proxy production module 100 with the production options and local file data received in step 124 (step 140). Hooking application 96 then resumes the execution of production application 84 with instructions to produce the document stored in step 124 (step 142).

Production application 84 unknowingly utilizes proxy production module 100 to produce the document (step 144). Proxy production module 100 loads the document using its temporary file data and directs production device 74 to produce the document according to the production options received in step 124. In doing so, proxy production module 100 uses, if necessary, the local file data received in step 124 rather than the temporary file data used to store the document on server 72. Beneficially, no further user interaction is required, and where the production options dictate that the document's file data is to be used, the local file data is used instead.

Although the flow charts of FIGS. 12 and 13 show specific orders of execution, the orders of execution may differ from that which is depicted. For example, the order of execution of two or more blocks may be scrambled relative to the order shown. Also, two or more blocks shown in succession in FIG. 12 or 13 may be executed concurrently or with partial concurrence. All such variations are within the scope of the present invention.

### EXAMPLE

FIGS. 14-21 provide examples that help to illustrate the contents of operational memory 82 as the steps of FIG. 13 are carried out. FIG. 14 illustrates operational memory 82 following step 122. Following step 122, hooking application memory space 148 contains hooking application 96, hooking module 98, and IAT 150 for hooking application 96.

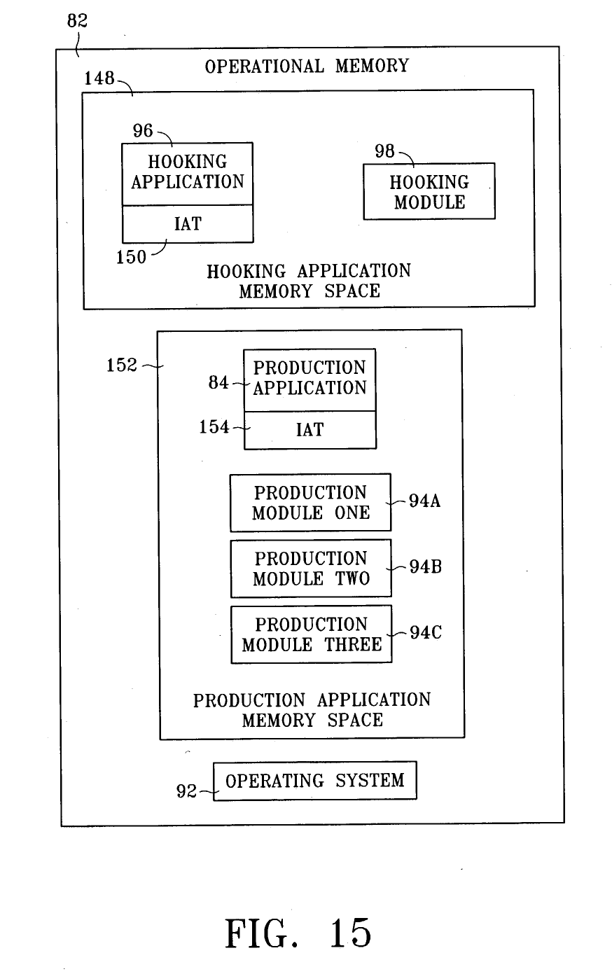

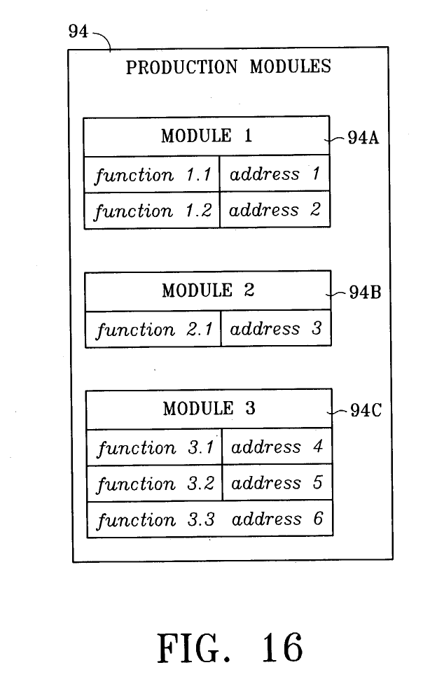

FIG. 15 illustrates operational memory 82 following step 128. Prior to loading production application 84, operating system 92 reserved memory space 152. In step 128, operating system 92, at the direction of hooking application 96, loaded production application 84 with its IAT 154 into memory space 152. Operating system 92 identified and loaded production modules 94. In the example of FIGS. 15 and 16, production modules 94 are listed as module one 94A, module two 94B, and module three 94C. Any number of modules may have been loaded in step 128. However, in this example, production application 84 only uses document production functions provided by modules one, two, and three 94A-94C. Referring to FIG. 16, module one 94A provides programming for two document production functions—function 1.1 accessible at address one and function 1.2 accessible at address two. Module two 94B contains programming for a single document production function—function 2.1 accessible at address three. Module three 94C contains programming for three document production functions—function 3.1 accessible at address four, function 3.2 accessible at address five, and function 3.3 at address six.

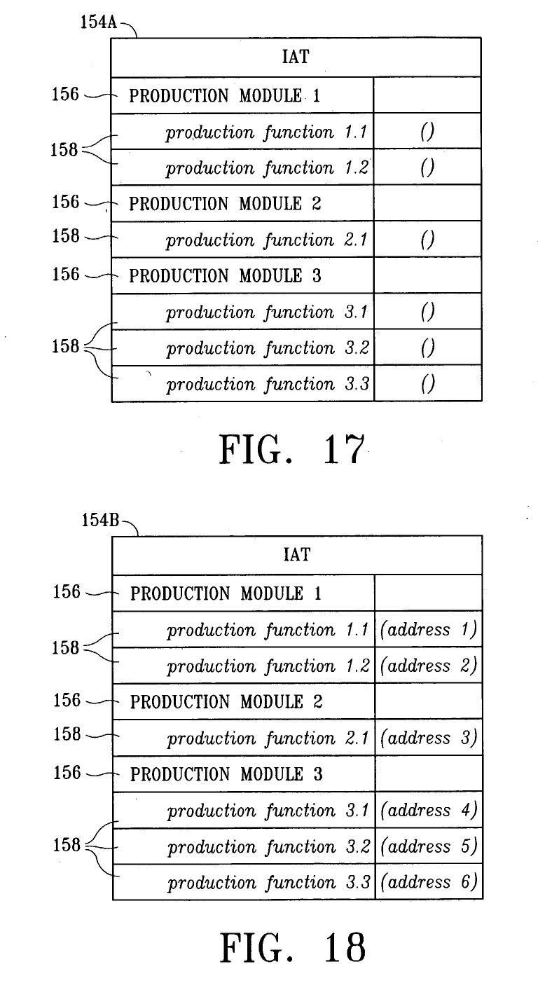

FIG. 17 illustrates IAT 154 for production application 84 before IAT 154 is updated by operating system 92. FIG. 18 shows IAT 154 after it has been updated. The before version of IAT 154, referenced as 154A, contains entries 156 for each production module 94 used by production application 84 and entries 158 for each document production function provided by production modules 94 and called by production application 84. IAT 154A, however, does not contain addresses in entries 158. The after version of IAT 154, referenced as 154B does contain addresses for the functions called by production application 84.

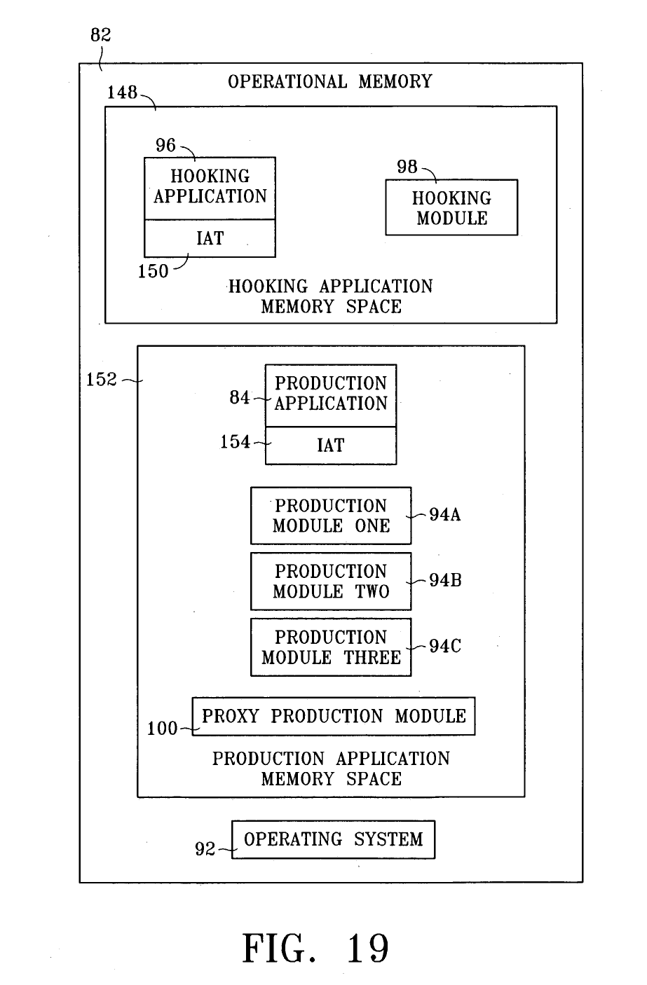

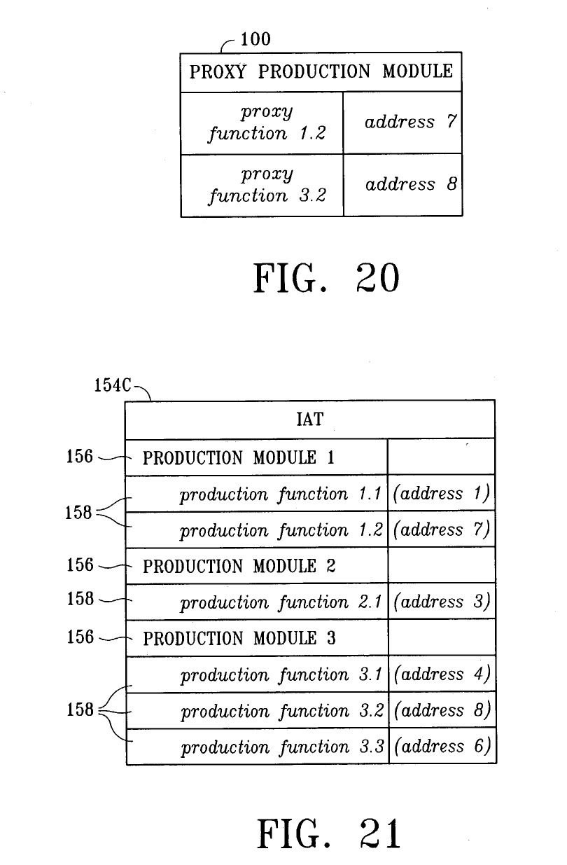

FIG. 19 illustrates operational memory 82 following step 134 in which proxy production module 100 was loaded into production application memory space 152. FIG. 20 illustrates proxy production module 100 in more detail. In this example, proxy production module 100 provides two proxy document production functions—proxy function 1.2 accessed at address seven and proxy function 3.2 accessed at address eight.

FIG. 21 illustrates IAT 154 after being revised by hooking application 96 in step 138. In the after version of IAT 154, referenced as 154C, the address for function 1.2 has been replaced with address seven—the address for accessing proxy function 1.2. The address for function 3.2 has been replaced with address eight—the address for accessing proxy function 3.2.

Following step 142, when the execution of production application 84 is resumed and production application 84 makes calls to document production functions 1.2 and 3.2, those calls are redirected to proxy functions 1.2 and 3.2 accordingly. However, as the programming for production application 84 has not been altered, the redirection is transparent to production application 84. It is important to note, that, while in the examples illustrated in FIGS. 14-22 only two function calls were redirected—functions 1.2 and 3.2 redirected to proxy functions 1.2 and 3.2—any number of function calls can be redirected.

The present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain programming for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only memory (ROM), an erasable programmable read-only memory, or a portable compact disc.

The present invention has been shown and described with reference to the foregoing exemplary embodiments. It is to be understood, however, that other forms, details, and embodiments may be made without departing from the spirit and scope of the invention, which is defined in the following claims.

What is claimed is:

1. A document production method, comprising:
initiating a production application;
causing calls from the production application to a document production function to be redirected to a proxy document production function; and
instructing the production application to produce a document.

2. The method-of claim 1, further comprising receiving the document along with production options, the method further comprising providing the production options to the proxy production function allowing the proxy production function to utilize the production options to assist the production application to produce the document without user interaction.

3. The method of claim 1, further comprising receiving the document along with local file data for the document, the method further comprising storing the document using temporary file data and providing the local file data to the proxy production function allowing the proxy production function to assist the production application to produce the document using the local file data rather than the temporary file data.

4. The method of claim 1, wherein causing comprises identifying, in an import address table for the production application, an address used to access the production function and replacing the identified address in the import address table with an address to be used to access the proxy document production function.

5. A document production method, comprising:
receiving a document to be produced along with production options;
providing the production options to a proxy production function;
initiating a production application;
causing calls from the production application to a document production function to be redirected to the proxy document production function;
instructing the production application to produce the document; and
wherein the proxy production module utilizes the production options to assist the production application to produce the document without user interaction.

6. The method of claim 5, wherein causing comprises identifying, in an import address table for the production application, an address used to access the production function and replacing the identified address in the import address table with an address to be used to access the proxy document production function.

7. A document production method, comprising:
receiving a document to be produced along with local file data for the document;
storing the document using temporary file data;
providing the local file data to a proxy production function;
initiating a production application;
causing calls from the production application to a document production function to be redirected to the proxy document production function;
instructing the production application to produce the stored document; and
wherein the proxy production function assists the production application to produce the document using the local file data rather than the temporary file data.

8. The method of claim 7, wherein causing comprises identifying, in an import address table for the production application, an address used to access the production function and replacing the identified address in the import address table with an address to be used to access the proxy document production function.

9. A document production method, comprising:
receiving a document to be produced along with local file data for the document and production options;
storing the document using temporary file data;
providing the local file data and production options to a proxy production function;
initiating a production application;
causing calls from the production application to a document production function to be redirected to the proxy document production function;
instructing the production application to produce the stored document; and
wherein the proxy production function assists the production application to produce the document using the local file data rather than the temporary file data, and wherein the proxy production module utilizes the production options to assist the production application to produce the document without user interaction.

10. The method of claim 9, wherein causing comprises identifying, in an import address table for the production application, an address used to access the production function and replacing the identified address in the import address table with an address to be used to access the proxy document production function.

11. Computer readable media having instructions for:
A initiating a production application;
causing calls from the production application to a document production function to be redirected to a proxy document production function; and
instructing the production application to produce a document.

12. The media of claim 11, having further instructions for receiving the document along with production options and providing the production options to the proxy production function allowing the production function to utilize the production options to assist the production application to produce the document without user interaction.

13. The media of claim 11, having further instructions for receiving the document along with local file data for the document, storing the document using temporary file data, and providing the local file data to the proxy production function allowing the proxy production function to assist the production application to produce the document using the local file data rather than the temporary file data.

14. The media of claim 11, wherein the instructions for causing include instructions for identifying, in an import address table for the production application, an address used to access the production function and replacing the identified address in the import address table with an address to be used to access the proxy document production function.

15. Computer readable media having instructions for:
receiving a document to be produced along with production options;
providing the production options to a proxy production function;
initiating a production application;
causing calls from the production application to a document production function to be redirected to the proxy document production function;
instructing the production application to produce the document; and
wherein the proxy production module utilizes the production options to assist the production application to produce the document without user interaction.

16. The media of claim 15, wherein the instructions for causing comprise identifying, in an import address table for the production application, an address used to access the production function and replacing the identified address in the import address table with an address to be used to access the proxy document production function.

17. Computer readable media having instructions for:
receiving a document to be produced along with local file data for the document;
storing the document using temporary file data;
providing the local file data to a proxy production function;
initiating a production application;
causing calls from the production application to a document production function to be redirected to the proxy document production function;
instructing the production application to produce the stored document; and
wherein the proxy production function assists the production application to produce the document using the local file data rather than the temporary file data.

18. The media of claim 17, wherein the instructions for causing comprise instructions for identifying, in an import address table for the production application, an address used to access the production function and replacing the identified address in the import address table with an address to be used to access the proxy document production function.

19. Computer readable media having instructions for:
receiving a document to be produced along with local file data for the document and production options;
storing the document using temporary file data;
providing the local file data and production options to a proxy production function;
initiating a production application;
causing calls from the production application to a document production function to be redirected to the proxy document production function;
instructing the production application to produce the stored document; and
wherein the proxy production function assists the production application to produce the document using the local file data rather than the temporary file data, and wherein the proxy production module utilizes the production options to assist the production application to produce the document without user interaction.

20. The media of claim 19, wherein the instructions for causing comprise instructions for identifying, in an import address table for the production application, an address used to access the production function and replacing the identified address in the import address table with an address to be used to access the proxy document production function.

21. A document production system, comprising:
a module loader operable to load a proxy production module into operational memory with a production application;
a reviser operable to cause calls from the production application to a document production function to be redirected to a proxy production function provided by the proxy production module; and
a hooking application operable to receive a document and direct the production application to produce the document.

22. The system of claim 21, wherein the hooking application is further operable to receive the document along with production options and provide the production options to the proxy production module allowing the proxy production function to utilize the production options to assist the production application to produce the document without user interaction.

23. The system of claim 21, wherein the hooking application is further operable to receive the document along with local file data for the document, store the document using temporary file data, and provide the local file data to the proxy production module allowing the proxy production function to assist the production application to produce the document using the local file data rather than the temporary file data.

24. The system of claim 23, wherein the reviser is further operable to identify, in an import address table for the production application, an address used to access the production function and replace the identified address in the import address table with an address to be used to access the proxy document production function.

25. A document production system, comprising:
a module loader operable to load a proxy production module into operational memory with a production application;
a reviser operable to cause calls from the production application to a document production function to be redirected to a proxy production function provided by the proxy production module;
a hooking application operable to receive a document along with production options, provide the production options to the proxy production function, and to direct the production application to produce the document; and
wherein the proxy production module utilizes the production options to assist the production application to produce the document without user interaction.

26. The system of claim 25, wherein the reviser is further operable to identify, in an import address table for the production application, an address used to access the production function and replace the identified address in the import address table with an address to be used to access the proxy document production function.

27. A document production system, comprising:
a module loader operable to load a proxy production module into operational memory with a production application;
a reviser operable to cause calls from the production application to a document production function to be redirected to a proxy production function provided by the proxy production module;
a hooking module operable to receive a document to be produced along with local file data for the document, to store the document using temporary file data, and to provide the local file data to the proxy production function; and
wherein the proxy production function assists the production application to produce the document using the local file data rather than the temporary file data.

28. The system of claim 27, wherein the reviser is further operable to identify, in an import address table for the production application, an address used to access the production function and replace the identified address in the import address table with an address to be used to access the proxy document production function.

29. A document production system, comprising:
a module loader operable to load a proxy production module into operational memory with a production application;
a reviser operable to cause calls from the production application to a document production function to be redirected to a proxy production function provided by the proxy production module;
a hooking module operable to receive a document to be produced along with local file data for the document and production options, to store the document using temporary file data, and to provide the local file data and the production options to the proxy production function; and
wherein the proxy production function assists the production application to produce the document using the local file data rather than the temporary file data and wherein the proxy production module utilizes the production options to assist the production application to produce the document without user interaction.

30. The system of claim 29, wherein the reviser is further operable to identify, in an import address table for the production application, an address used to access the production function and replace the identified address in the import address table with an address to be used to access the proxy document production function.

31. A document production system, comprising:
a means for loading a proxy production module into operational memory with a production application;
a means for causing calls from the production application to a document production function to be redirected to a proxy production function provided by the proxy production module;
a means for receiving a document to be produced along with local file data for the document and production options;
a means for storing the document using temporary file data;
a means for providing the local file data and the production options to the proxy production function; and
wherein the proxy production function assists the production application to produce the document using the local file data rather than the temporary file data and wherein the proxy production module utilizes the production options to assist the production application to produce the document without user interaction.
